(19) United States
(12) Patent Application Publication
(10) Pub. No.: US 2026/0291916 A1
(43) Pub. Date: Sep. 24, 2026

(54) AUTOMATED UPDATES FOR FIREWALL RULESETS WITH CLUSTERING AND ATTACK SUBSTRING COMPARISON

(71) Applicant: Akamai Technologies, Inc., Cambridge, MA (US)

(72) Inventor: Akul Dewan, Roswell, GA (US)

(21) Appl. No.: 19/444,748

(22) Filed: Jan. 9, 2026

Related U.S. Application Data
(63) Continuation of application No. 19/444,484, filed on Jan. 9, 2026.
(63) Continuation of application No. 19/444,699, filed on Jan. 9, 2026.
(60) Provisional application No. 63/776,169, filed on Mar. 23, 2025.
(60) Provisional application No. 63/900,522, filed on Oct. 16, 2025.

(51) Int. Cl. H04L 9/40

(52) U.S. Cl. CPC H04L 63/0263

(57) ABSTRACT

An ML-based traffic analyzer, attack detector, and rule generator is described. An ML model is trained on semi-structured data from network traffic and learns to predict sequences in that data that correspond to any one of several target attributes. The ML model tags the location of such sequences using a parts of speech technique. The target attribute can be an attack of a given type, for example with the tagged sequences identifying the location of a malicious substring associated with the attack vector. Such information can be used to develop rulesets for use in a network filter to block such traffic.

### BACKGROUND

### Technical Field

This application generally relates to the use of machine learning in internet infrastructure and distributed computing systems.

### Brief Description of the Related Art

Trained machine learning (ML) models are used to evaluate an input (such as network traffic) for a desired purpose, such as to classify the input. Models are typically trained in an offline, non-production environment, e.g., by curating data for training and feeding that data into a carefully designed ML model in a lab setting. Once trained, models are deployed to live production systems, where the model is used for inferencing, meaning that new, live data is applied to the ML model. The ML model produces an output, such as the classification with a confidence score. The output is commonly referred to as the ML model's ‘prediction’. Over time, however, ML model's performance may degrade, which is a problem sometimes referred to as ‘drift’.

Drift is a problem, for example, in the realm of network security, in which a trained ML model might be used to classify traffic as benign or an attack. Drift can occur for many reasons, but the underlying issue can be that the training data has become stale. As a remedy, the ML model can be retrained on updated or more accurate data, and then the production ML model can be upgraded to the newly trained ML model. This approach however is cumbersome.

The teachings hereof present new and improved approaches in the field of ML models and the application of such models to analyze network traffic. The teachings hereof also present new and improved approaches for integrating ML models into the operation of network infrastructure, including in particular with security platforms.

### BRIEF DESCRIPTION OF THE DRAWINGS

The invention will be more fully understood from the following detailed description taken in conjunction with the accompanying drawings, in which:

FIG. 1 is a diagram illustrating a ML-based system in accordance with an embodiment of the teachings hereof;

FIG. 2A is a diagram illustrating aspects of the MMRC 104 component shown in FIG. 1, in accordance with an embodiment of the teachings hereof;

FIG. 2B is a diagram illustrating aspects of the encoder module 202 component shown in FIG. 2A, in accordance with an embodiment of the teachings hereof;

FIG. 2C is a diagram illustrating aspects of the MMRC 104 component shown in FIG. 1, in accordance with an embodiment of the teachings hereof;

FIG. 2D is a diagram illustrating aspects of the MMRC 104 component shown in FIG. 1, in accordance with an embodiment of the teachings hereof, and,

FIG. 3 is a flowchart illustrating operation of the ML-based system, in accord with an embodiment of the teachings hereof;

FIG. 4 is a flowchart illustrating operation of the ML-based system, in accord with an embodiment of the teachings hereof, and,

FIG. 5 is a diagram illustrating computer hardware that may be used to implement the teachings hereof, in accordance with an embodiment of the teachings hereof.

Numerical labels are provided in some FIGURES solely to assist in identifying elements being described in the text; no significance should be attributed to the numbering unless explicitly stated otherwise.

### BRIEF SUMMARY

This section describes some pertinent aspects of this invention. Those aspects are illustrative, not exhaustive, and they are not a definition of the invention.

An ML-based traffic analyzer, attack detector, and rule generator is described. An ML model is trained on semi-structured data from network traffic and learns to predict sequences in that data that correspond to any one of several target attributes. The ML model tags the location of such sequences using a parts of speech technique. The target attribute can be an attack of a given type, for example, with the tagged sequences identifying the location of a malicious substring associated with the attack vector. Such information can be used to develop rulesets for use in a network filter to block such traffic. In addition to making predictions about traffic, the system may also automatically determine the need for, and generate, updated rulesets for network filters. Such updated configurations can include new or improved filtering rules for the network filter that operate to find and block predicted attack substrings, as well as automatically optimized rulesets.

The claims are incorporated by reference into this section, in their entirety.

### DETAILED DESCRIPTION

The following description sets forth embodiments of the invention to provide an overall understanding of the principles of the structure, function, manufacture, and use of the methods and apparatus disclosed herein. All of the subject matter described in this application and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references cited anywhere in this document are expressly incorporated herein by reference in their entirety, and for all purposes. The term “e.g.” used throughout is used as an abbreviation for the non-limiting phrase “for example.”

The teachings hereof may be realized in a variety of systems, methods, apparatus, and non-transitory computer-readable media. It should also be noted that the allocation of functions to particular machines is not limiting, as the functions recited herein may be combined or split amongst different hosts in a variety of ways.

Any reference to advantages or benefits refer to potential advantages and benefits that may be obtained through practice of the teachings hereof. It is not necessary to obtain such advantages and benefits in order to practice the teachings hereof.

All references to HTTP should be interpreted to include an embodiment using encryption (HTTP/S), such as when TLS secured connections are established. While context may indicate the hardware or the software exclusively, should such distinction be appropriate, the teachings hereof can be implemented in any combination of hardware and software. Hardware may be actual or virtualized.

The acronym ‘ML’ refers to “machine learning”.

### Overview

An ML-based traffic analyzer, attack detector, and rule generator for a network filter is described. An ML model is trained on semi-structured data from network messages and learns to predict sequences in that data that correspond to any one of several target attributes. The ML model tags the location of such sequences. The target attribute can be an attack of a given type, for example, with the tagged sequences identifying the location of a malicious substring that evidence the attack. Such information can be used to configure the operation of the network filter to block such traffic. Beyond making predictions about traffic, the ML model can also learn to generate actionable configurations for the network infrastructure, such as new or improved filtering rules for the network filter. The teachings hereof can be applied not just to one network filter but also to a platform of many distributed network filters.

As one example, assume the network filter is an application layer firewall. The target attributes can be attack vectors—such as SQL injection, cross site scripting, and remote code execution—related to attacks that may be directed to a web application, API, or other application layer endpoint. In this case, the sequence predicted by the ML model is a sequence of characters in an HTTP request that represents or is indicative of the target attack. For a given message, multiple contiguous sequences corresponding to multiple attacks are predicted The ML model tags the location of the attacks using an OBIE tagging scheme, where ‘O’ is not part of the attack (“Outside”), ‘B’ is the beginning of the attack sequence, ‘E’ is the end of the attack sequence, and ‘I’ is the interior of the attack sequence. This scheme is referred to in the art as “Part of Speech” tagging.

Continuing the example, to train the ML model, a set of training data can be derived from the operations of an existing application layer firewall. The existing application layer firewall executes a filtering ruleset on network traffic, looking for attacks. These rulesets are typically expressed in the form of regular expressions, or ‘regexes’ for short. When the firewall detects an attack, the existing application layer firewall captures the input network message containing the detected attack and stores it with a label indicating the attack vector. The training data can be created from these captured messages and these labels. The training data can be processed by an encoder that performs normalization, tokenization, and other encodings, as well as complex embedding tasks. Hidden layers perform deep learning on the labeled data. A cross entropy loss function provides feedback; preferably this function is customized to penalize the model when it misses attacks found by the existing application layer firewall, but not when the model finds attacks that were not detected by the existing application layer firewall.

Extending the example above, the predicted sequences can be fed into a second stage of the ML model that is trained to generate regular expressions that will detect the tagged attack sequences. The generated regular expressions can be used in a number of ways, e.g., to supplement, improve, replace or be combined with existing regular expressions installed in the existing application layer firewall.

Multiple ways to implement the second stage are disclosed. One way is to use a neural net based decoder (“NN decoder” for short) and another way is to use a decoder implemented with a clustering approach (“clustering decoder” for short).

For the NN decoder, the input is a network message and a predicted and tagged sequence of characters in the network message. The sequence is a substring within the larger network message. With HTTP, the substring is a substring within the string of semi-structured data. The NN decoder model is trained to predict a cluster for the attack substring and, for each cluster, one or more regular expressions for finding the constituent substrings.

To train the NN model, data collected from the existing application layer firewall can be used. As mentioned, the existing application layer firewall can detect an attack based on regular expression being matched. Hence the existing application layer firewall can produce a set of training data including: the input network message, the detected attack vector label, and an indication of the regular expression that detected the attack.

The clustering decoder operates in a different way. The clustering decoder builds a set of clusters of attack substrings, e.g., a clustering algorithm such as k-means clustering or DBSCAN, for example, on known attack substrings. Hence, each cluster is a group of substrings with similar features. Each cluster is also associated with one more regular expressions that were developed using regex generation libraries or otherwise, which will be described in more detail later.

In operation, the cluster decoder associates the newly detected attack substring to one of the clusters based on similarity scoring. A substring falling within a given cluster means that the regular expression(s) for that cluster are likely to find it. The level of coverage can be assessed over time and new regular expressions generated as needed to cover the clusters. Newly formed clusters will also result in new regular expressions associated therewith.

With additional processing, and from time to time, the system can analyze the set of predicted regular expressions from either of the NN approach and/or the clustering approach, and attempt to optimize them, e.g., by merging them or simplifying them. Similarly, the set of predicted regular expressions can be analyzed in view of the existing regular expressions in the existing application layer firewall, attempting to merge, supplement, or otherwise optimize them. In some cases, it may be necessary to generate a new cluster and new regular expression, if the attack substring is sufficiently different that it cannot be classified into one of the existing clusters.

Thus, in one embodiment, the ML model has a first stage (encoder) and a second stage (NN based decoder or clustering decoder). The encoder learns Part of Speech tagging on the semi structured messages, and the decoder produces regular expressions to install in a network filter to find them.

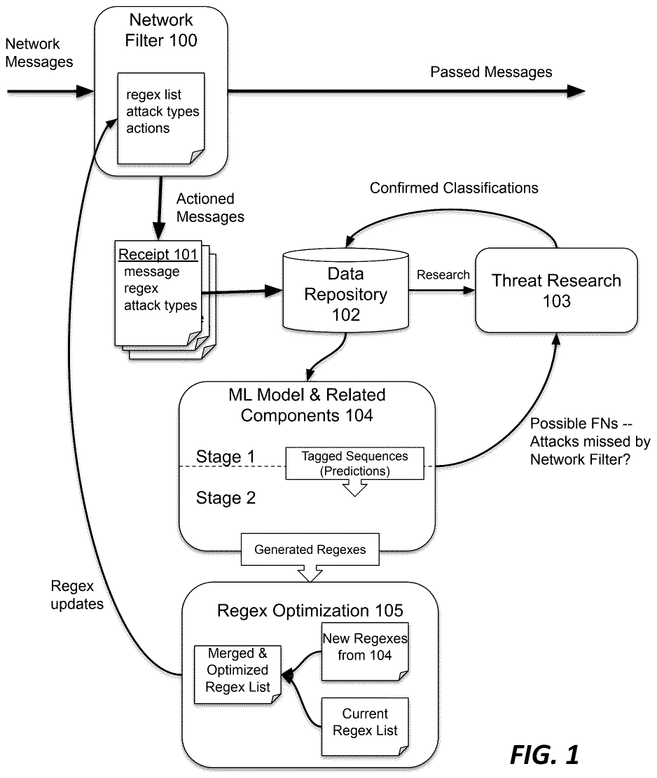

### FIG. 1 & System Diagram

FIG. 1 illustrates an embodiment of the overall system at a high level.

Network filter 100 is deployed on a network and it filters traffic according to a configuration of regular expressions (the filtering rules). In this example, the network filter functions as an application layer firewall that receives HTTP messages (typically HTTP requests, but also responses) and performs deep packet inspection. The network filter's purpose is to detect attacks on an upstream server that the firewall is protecting (not shown). The teachings hereof can be extended to other use cases, including filtering for other purposes and different types of traffic. HTTP messages are semi-structured data and the teachings hereof apply without limitation to such semi-structured data.

The deep packet inspection performed by the network filter 100 involves applying the regexes to the HTTP messages, determining whether a regex is triggered indicating an attack (sometimes referred to as ‘matching’ on the message). Each regex looks for a particular type of attack. If the regex is triggered, the network filter 100 identifies the attack vector and performs an action (e.g., block the traffic, allow the traffic but generate an alert) per an internal configuration stored at the network filter 100. More information about basic operation of a network filter in the role of an application layer firewall can be found in U.S. Pat. No. 8,458,769, titled “Cloud based firewall system and service”, issued Jun. 4 2013, and in U.S. Pat. No. 11,012,416, titled “Symbolic Execution For Web Application Firewall Performance” issued May 18 2021, the teachings of which are hereby incorporated by reference in their entirety.

Messages that do not trigger any rules are passed to the destination. Messages that trigger one or more rules and hence result in an action cause the network filter 100 to generate a receipt 101. The receipt 101 contains the message or at least a portion of the message that triggered the regex. The receipt 101 also contains the regex that was triggered, and the attack vector. These receipts may be aggregated or compressed in conventional ways, and they are stored in data repository 102.

Though not shown explicitly in FIG. 1, the threat research 103 team may add known bad traffic or good traffic, or otherwise to data repository 102. For example, OpenAppSec provides examples of traffic with known good or bad characteristics.

The module labeled ML Model & Related Components 104 (MMRC 104) represents the core of the system and will be described in more detail below. In FIG. 1, the MMRC 104 is shown as having two stages. The first stage is sometimes referred to as the encoder stage. In this implementation, the first stage is a neural network based ML architecture and more specifically a transformer architecture. The neural network may use recurrence and some may consider it a recurrent neural network for that reason. The input to the first stage is the aforementioned receipt data 101 and other data stored in the data repository 102. The goal of the first stage is to take in a network message, or metadata about that message, and to generate a prediction about whether the message has one or more attributes. The attributes it is looking for are the attack vectors. Put another way, an attack vector is an attribute.

The receipts 101 and/or other data are labeled training data (label being the attribute of an attack vector). Once trained, the output of the first stage is a prediction of an attack vector in an input network message. The first stage uses a sequence tagging approach to express its prediction. Characters in the message are tagged, or labeled, according to an OBIE system. In the OBIE system, O stands for outside of an attack, B stands for beginning of an attack sequence,I stands for the interior of the attack sequence, and E stands for the end or final character of the attack. If an attack is found, the substring indicating the attack is labeled BIE, where the number of I labels varies with the length of the substring. If no attack is found, then every character in the message would be labeled as ‘O’.

When the MMRC 104 identifies an attack that the network filter 100 missed, that prediction can be fed back to the threat research 103 function, as shown in FIG. 1. Once threat research 103 validates the finding (e.g., that there was an attack and hence the network filter had a false negative or FN), that network message can be labeled with the attack vector and stored into the data repository 102. That represents a reinforcement learning loop for the MMRC 104. Similarly, it is possible that the network filter 100 finds one attack in a network message, but misses others also present therein. This is because network filter 100 operation is expensive, so generally a network filter 100 will stop processing once a first attack is found and take the configured action to block or otherwise mitigate. If the MMRC 104 finds additional attacks in a network message, this signal is fed back to the threat research 103 function for reinforcement learning, too.

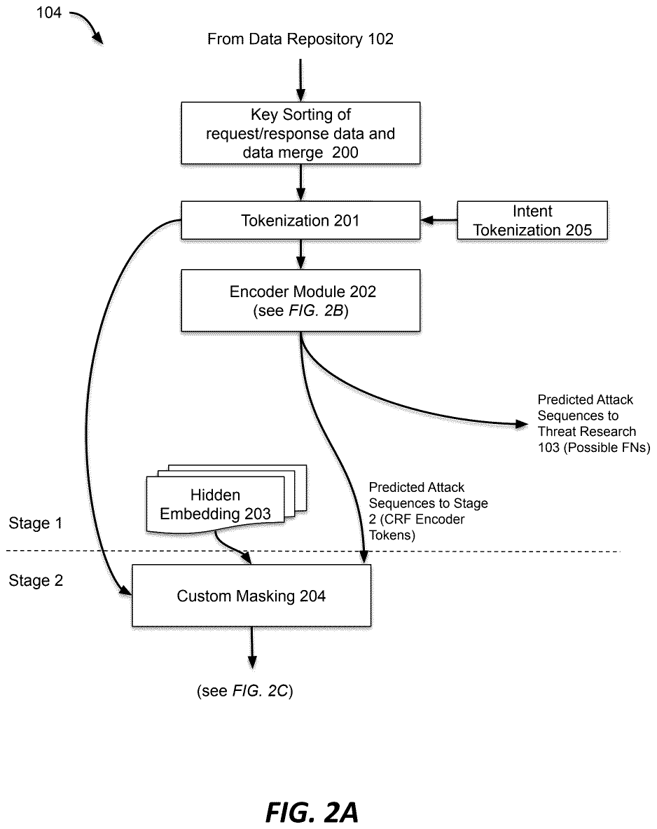

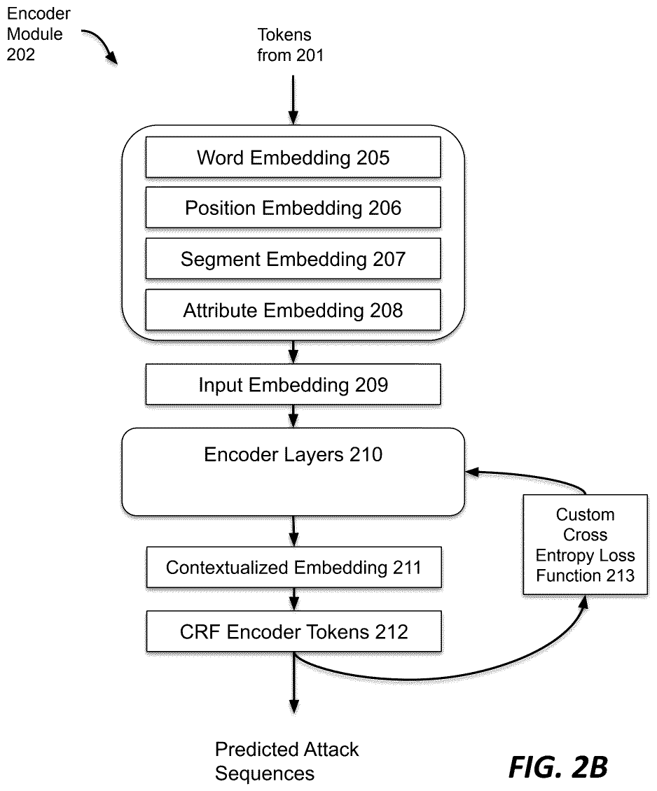

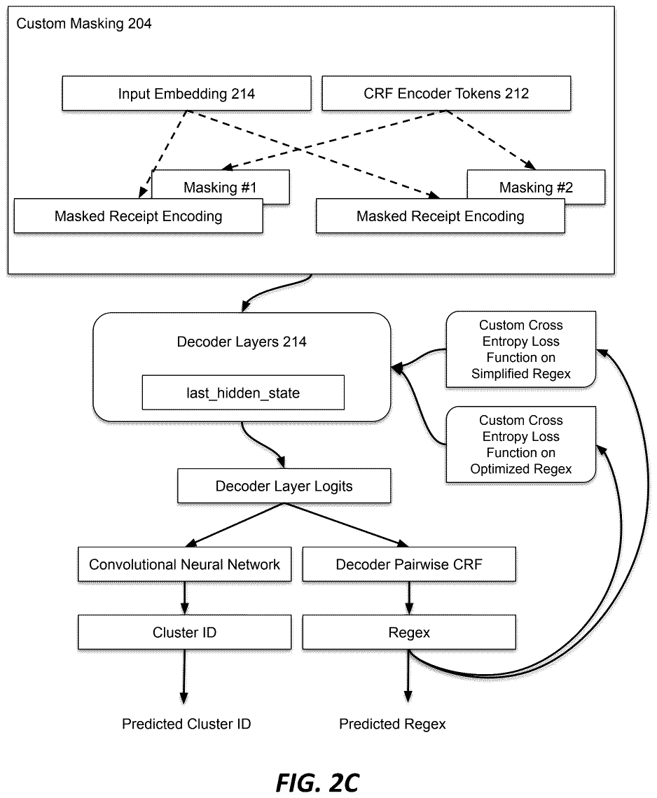

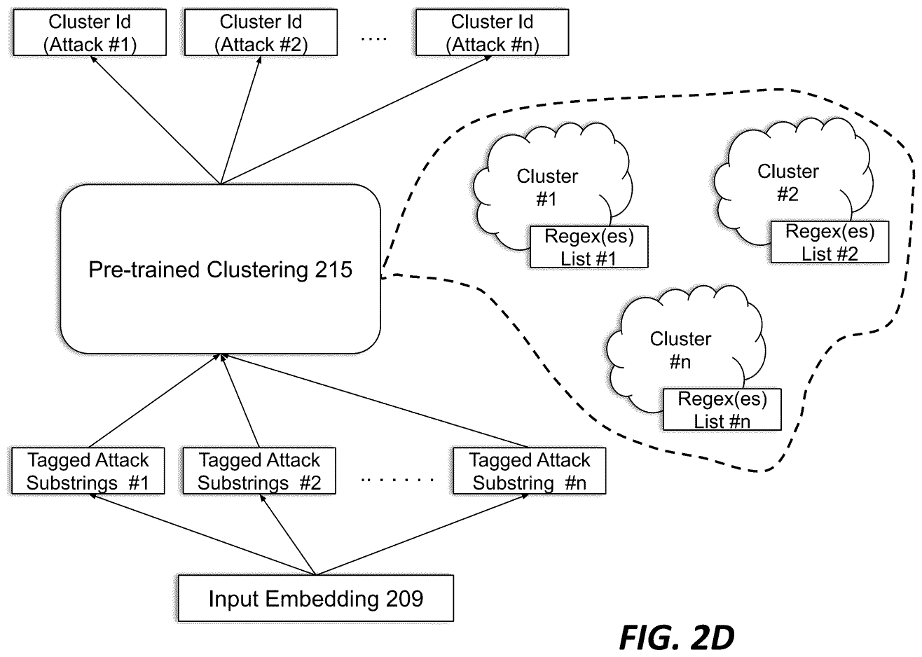

The foregoing is a generalized summary. MMRC 104 stage 1 is shown and described in more detail in FIGS. 2A and 2B.

As mentioned earlier, the second stage of the MMRC 104 is a decoder that takes the predicted attack substrings as input and generates one or more regexes for use by the network filter to find the attack sequence in network messages. There are two versions of the decoder are presented herein. The NN decoder uses a neural network trained on the receipt 101 data plus the tagged sequences, which collectively contain the network message, the substring constituting the attack, and the regex in the network filter 100 that found the attack. The NN decoder is presented and described in more detail with respect to FIG. 2C. The clustering decoder clusters predicted attack sequences using a clustering algorithm such as DBSCAN or k-means and for each cluster, one or more regexes are developed. The clustering decoder is presented and described in more detail with respect to FIG. 2D.

Generated regexes are sent from the MMRC 104 to the regex optimization component 105. The function of the regex optimization 105 is to take a set of two or more regexes and optimize them. This function may include combining, merging, simplifying and consolidating the set of regexes to provide a regex list that is easier for the network filter 100 to process. The regex optimization 105 may operate in at least two areas: optimizing predicted regexes from stage 2 of the MMRC 104 from across clusters, and optimizing the predicted regexes with the regexes that are already installed in the network filter 100. The result is an updated regex list that is pushed to the network filter 100 as an update.

### FIG. 2A & Detailed Description On MMRC 104

FIG. 2A illustrates an embodiment of the MMRC 104 in more detail.

At block 200 the MMRC 104 pulls and pre-processes the data from the data repository 102. Pre-processing the data means that the network messages, the attack vectors, and other data must be generalized. Literals and variables may be replaced with constant filler value. Certain things such as defined elements (e.g., in HTTP elements, SQL expressions) are identified and tokenized so they remain intact.

Many conventional parsing and normalization tools are available that can perform the necessary functions. For example, Antlr is a community supported tool with available parser languages. There is support for various dialects of SQL, Javascript, User-Agent (separately) and other programming languages. Additionally, it allows for easier extension of parsing expressions and literals.

Tokenization 201 can be performed in a variety of ways. Tokenization 201 maps normalized expressions to tokens in a system dictionary. Hence certain things like HTTP header fields, method types, or the like are mapped to defined token values. To expand the vocabulary with new expressions, the system can select the top recurring expressions and add these to the custom encoder. Then it can re-tokenize the receipts 100 and other data from the data repository 102 with the new expressions. This information is used throughout the MMRC 104.

The tokenization process 201 can include intent tokenization 205. With intent tokenization, an ML model learns to interpret a corpus of data such as a programming language or text, and to produce a prediction of what it is trying to do—the “intent”. In the MMRC 104, an intent model is utilized to analyze data in the receipts 101—particularly the network messages. So for example the intent model produces an encoded prediction of intent of what the HTTP request is doing, and/or what the payload such as a SQL statement is doing. A suitable intent model is the CodeT5 pretrained model, which was developed for programming languages but which can be repurposed for the teachings hereof. The predicted intent is tokenized and attached to the receipts 101 data. More specifically, the steps are:
First decode substrings using tokenizers.
Encoding substrings using CodeT5 tokenizer.
Using CodeT5 to get a summarization of substrings.
Use encoded, summarization text for hidden layer generation.

The encoder module 202 in FIG. 2A contains many subcomponents to support a transformer based ML model. It is shown in more detail in FIG. 2B.

### FIG. 2B & Detailed Description of Encoder Module 202

The encoder module 202 performs several embeddings as shown in FIG. 2B.

Word Embedding 205 produces a representation of input tokens in higher dimensional space.

Position Embedding 206 produces positional information of each token in higher dimensional space.

Segment embedding 207 produces segment information (e.g., identifying parts of HTTP request) represented in higher dimensional space. More specifically, segment embedding 207 involves identifying locations in the network message that may be of significance in detecting attacks. Segment embedding 207 expresses locations to the model so that the model can learn where attacks tend to occur in the context of the network message's structure. For example, attacks of certain types often are found (and the network filter 100 may have found an attack) in a particular message header field, or a message body. The information is added to the segment embedding layer appended to the word and positional embedding layer. For example, assuming the network message is an HTTP request, a simplified example with three user agent words and four cookie words, this may look like an array=[<user-agent-id>,<user-agent-id><user-agent-id>,<cookie-id>,<cookie-id>,<cookie-id>,<cookie-id>]

The above example means that the first three words of the HTTP message string are the user agent header field, and the second three words are the cookie header field.

The segment embedding information can be appended to the word and positional embedding layer.

Attribute Embedding 208 produces attack vector and group information embedded, as a question, represented in higher dimensional space. More specifically, attribute embedding is used as a question to the language model. For example, adding attribute X to the embedding layer means the model is expected to produce results corresponding to X. All the attributes that the model will be trained on can be defined in this embedding. These are attack vectors, sometimes referred to as attack groups. The training dataset will repeat the same receipt 101 for each attack vector, but with one attack vector having non-null values, and the rest being null values. On testing, each request to the model will query for each attribute (each attack vector).

Input embedding 209 takes the preceding embeddings and produces a merge for input to the encoder layers 210. A variety of merge approaches can be used, including sum, concatenation or hybrid merge of word, positional, segment and attribute embedding.

The encoder layers 210 are neural network (NN) layers that employ a self-attention mechanism to produce an output using a part of speech tagging technique. Part of speech tagging involves tagging portions of an input sequence with tags from a limited tag set. In this embodiment, the input network message (e.g., the HTTP request) is converted into a sequence of tags from the set {O,B,I,E}. As mentioned earlier, ‘O’ is not part of the attack (“Outside”), ‘B’ is the beginning of the attack sequence, ‘E’ is the end of the attack sequence, and ‘I’ is the interior of the attack sequence. The input sequence may be tagged on a character by character basis.

The encoder layers 210 produce a sequence of tags, a collection of characters ({B, I,O, E}) of the same length as the input sequence. It represents one or more sub-sequences of beginning and end indexes within the input token.

The contextualized embedding 211 will merge the network message in the receipt 101 which is encoded, with the pre-processing mentioned before: normalized substring, identified expressions, segment embedding, intent embedding from CodeT5 model, and so on. The recommended merge approach is concatenation, so as to preserve the data.

The contextualized embedding 211 produced by the encoder layer 210 are processed by a linear condition random fields (CRF) class. CRF is a probabilistic function that is applied on the output logits of an encoder/decoder. This function adds a layer of probability on the token being predicted, the probability is dependent on the input and on the previous tokens also predicted. Essentially, this function adds the inherent dependencies between output tokens.

CRF Tensor Conversion. To convert the CRF output in 212 to classification probabilities, the approach can include: get probabilities by softmax/or argmax, convert tokens to string.

The CRF output 212 produced are linearly transformed to a string containing four classes of sequence tagging as required for this application, namely the OBIE tagging. The CRF tensor conversion can be implemented using known programming libraries such as PyTorch. Generally, the process is:
Import the module torchcrf
Add the layer to the encoder's self—torchcrf.CRFLayer(num_labels)
In forward, the output of the transformer will be logits.
The logits will then be passed to the linear fc layer for classification.
The fc layer output will be passed to CRF.
loss=−self.crf(logits, tags, mask) (here tags is actual sequence tagging from the training dataset).
best_tags=self.crf.decode(logits, mask)

The CRF output from the encoder module 202 are tagged sequences. They can be used to generate masking information. The masking information is a mask that leaves only the substring identified by the encoder as an attack. For each of the substring identified in the network message, the NN decoder will be provided with masking information. This will be described in more detail in FIG. 2C.

A custom cross entropy loss function 213 is applied to the output of the encoder 202 to assess loss during training. As known in the art, the purpose of the loss function is to quantify the difference between the label and the prediction of the model. Loss functions are known in the art. In this implementation, however, a custom function is used because the ML model might detect attacks that the network filter 100 missed (false negative). Detections of these false negatives are differences but the model should not be penalized for them but rather incentivized to find them. It also should be incentivized to find the attacks that the network filter did (true positives), while not flagging the benign traffic (true negatives). Put another way, the ML model should be at least as good as the network filter 100 in finding attacks, and hopefully better.

### FIG. 2C & Detailed Description of NN Type Decoder

FIG. 2C is a continuation of FIG. 2A and it illustrates details of stage 2 implemented using the NN decoder.

The custom masking 204 component is the interface between the encoder (stage 1) and the NN decoder (stage 2) in the overall MMRC 104 architecture. At box 214, custom masking 204 involves producing an encoded version of the input data from the receipt 101 (the HTTP request or other network message, the regex, etc.) using the same input embedding scheme described earlier in connection with FIG. 2B, 205 through 209. Custom masking 204 then masks these inputs using the information from the CRF encoder tokens 212 from the encoder (as shown and mentioned above for FIG. 2B).

The masking hides aspects of the network messages other than the sequences (the substrings) in the network messages that the MMRC 104 predicted to be attacks.

For training purposes, the decoder layers 214 ingest this masked input, along with the regex from the receipt 101 that detected the attack, and the cluster identification. The decoder layers 214 are neural network (NN) layers. The decoder layers 214 learn to predict a regex (or multiple regexes) that will find the unmasked data in the network messages, and also predicts a cluster identification. A confidence score may be included.

One or more regexes is generated for each of the clusters.

The purpose of producing a cluster assignment for a given input attack substring is to provide interoperability with the clustering decoder in FIG. 2D, and to help merge groups of predicted regexes (e.g., FIG. 1, box 105).

Two loss functions are used. Simple Loss—This uses regex library output as the prediction output compared with expected regex using a cross-entropy loss function, which is a loss function that is common and known in the art. The idea is to let the model in the right path. Optimization Loss—uses a genetic algorithm to optimize the regex and then calculate the fitness of regex to optimize it.

### FIG. 2D & Detailed Description of Clustering Decoder

FIG. 2D is a continuation of FIG. 2A and it illustrates details of stage 2 implemented using the alternative of the clustering decoder.

This embodiment involves clustering similar attack substrings, with each cluster being associated with one or more regular expressions that detect the cluster's attack substrings in network traffic.

Initially, a corpus of known attack substrings (e.g., through operation of the network filter 100 and/or threat research 103) can be clustered using an algorithm such as DBSCAN or k-means. This is shown in FIG. 2D as the pre-trained clustering operation 215. Put another way, each cluster is a set of attack substrings or tagged attack sequences, that have similar attributes.

When new attack substrings are identified by the system (tagged attack substrings #1, #2, etc. in the diagram), they are evaluated for similarity to an existing cluster. Similarity scoring and cluster assignment can be accomplished using a variety of conventional techniques. There are three possibilities as a result of this evaluation:
1. The new attack substring is sufficiently similar to an existing cluster. (E.g., similarity score above a configured threshold.) The attack substring is placed into that cluster and the existing regular expressions are tested to see if they will find the new attack substring. To conduct this test, a known tool such as PCRE (Perl Compatible Regular Expressions library) can be used. If the existing regular expressions are sufficient, then the process is complete.
2. The new attack substring is sufficiently similar to an existing cluster, however the existing regular expressions for that cluster do not cover the new attack substring. In this case, a new regular expression is generated and added to the regular expression set for the cluster. Then, an optimization procedure is executed to optimize the set of regular expressions. Optimization can be performed at regular intervals, also.
3. The new attack substring does not fit into any existing cluster. A new cluster can be created for this attack substring, with a newly generated regular expression. Preferably, before creating a new cluster the system monitors network traffic to see if this new attack substring occurs with sufficient frequency and across a sufficient breadth of traffic to warrant the creation of a new cluster.

### Regular Expression Generation

To generate a new regular expression for an attack substring, known tools for regex generation such as ‘DEAP’ (Distributed Evolutionary Algorithms in Python), ‘rstr’ (in Python) or ‘regexgen’ (in Python) can be used. An iterative process can be used in which, first, anchor points in a given attack substring (e.g., keywords) are identified and reflected as root nodes in a tree structure. Then the algorithm walks both forward and backwards from the anchor points, adding regular expression logic to find the necessary sequence of characters to reach the anchor point (root node). Walking stops when the algorithm reaches an adjacent anchor point, or a boundary between anchor points, or an end of the attack string.

### Regular Expression Optimization

The goal of generating a set of regular expressions is to install them into the network filter and use them to detect incoming attacks. Executing regular expressions against network traffic comes with a performance impact and cost. Therefore it is desirable to minimize the number of regular expressions per cluster, as well as the complexity (which is often indicated by the length) of each regular expression.

According to this disclosure, a genetic algorithm can be used to find an optimized set of regular expressions that meet the above needs. As known in the art, a genetic algorithm is an algorithm that starts with an initial population of individuals, where the individuals represent solutions to a problem. The algorithm iterates across N generations to find optimized individuals and/or a population, given a fitness function that describes desirable and perhaps undesirable properties. With each generation, operations such as mutation or crossover are performed on the individuals. Features of the individuals (such as elements of a regular expression, as relevant here) are thus changed over generations to arrive at an “evolved” solution.

In one embodiment, a genetic algorithm is used to find a set of regular expressions that covers the attack substrings in the cluster while excluding substrings outside of the cluster. The genetic algorithm is also incentivized to find shorter regular expressions to accomplish these goals and can be configured with a length limit.

The initial population can be set as the currently installed regular expressions for the attack, plus a newly generated but naive regular expression for the new attack substring. A naive regular expression can be produced using anchor point and tree structure approach, as described in the prior section. A naive regular expression might be produced, for example, as an ordered search for the language-specific characters or elements in a substring (e.g., the SQL characters/elements) with wildcards for other positions.

The fitness function is preferably a non-dominant algorithm tuned for precision, such that coverage of the attack substrings in the cluster are weighted positively, while coverage of substrings outside the cluster (e.g., which would cause false positives) are weighted negatively. The overall fitness is thus dependent both on maximizing coverage of true positives and minimizing false positives. Furthermore, a constraint on the length of a regular expression is applied, and a negative weight on length (if less than the length constraint) can be used.

The nature of genetic algorithmic solutions are to find a best fit individual(s), which put another way is a solution that performs best according to the fitness function. However, in accord with the teachings hereof, preferably the fitness function also includes other guardrails that prohibit certain solutions, which are sometimes referred to as negative examples. For example, a regular expression that matches on all substrings is prohibited, as is one that matches on all punctuation, or common database operators or data formats, or one that matches on impossible or overbroad application layer messages, and so on. The negative examples can be developed from the following principles:
(i) A regex should not find a substring that violates constraints imposed by the targeted application. Put another way, the genetic algorithm should not waste processing to find (and does not need to find) a regex that covers an input that the application cannot interpret, i.e., will produce an error. For example, if the substrings are from a SQL based attack, then a negative example is a substring that contains no SQL keywords, or that contains no spaces, or that places a FROM before SELECT rather than vice versa. Similar negative examples can be developed for an attack aimed at exploiting applications, including HTTP itself.
(ii) A regex cannot be a solution if it does not contain a keyword or order of keywords necessary for an application targeted by the attack to function. Hence, a negative example would be a substring that reverses the order of SQL keywords (reverse nested SELECT statements or other keywords).

To expedite and improve the genetic algorithm's execution, nearby clusters are also identified, and the attack substrings in those clusters are applied as constraints, meaning that the solution should not cover those attack substrings. This approach helps to bound the solution with the nearest neighbor clusters, and force the algorithm to more quickly explore the appropriate solution space. It also tends to limit the length of the regex solution.

After running through a configured number of generations, the genetic algorithm produces its solutions, which are one or more regular expressions that cover the attack substrings in the cluster. This can be tested and then used as an updated regular expression set, representing a subset of the overall set of regular expressions installed in the network filter.

‘Early stop’ triggers can be implemented in the genetic algorithm such that the algorithm terminates searching upon reaching a minimum number N of generations and the current population has a solution that meets certain ‘good enough’ criteria (e.g., detect at least X percent of substrings in the cluster and detect at most Y percent of substrings out of the cluster). This approach can be used to reduce processing time and is a variant of a known approach referred to as ‘hall of fame’ in which the top N performing solutions are saved as the algorithm continues to run. The use of these kinds of improvements is often necessary or desirable because given its nature, a genetic algorithm may not stay in an optimal solution space but rather over time move away from the optimal solution in its search.

The approach described above has focused on the generation of an optimized set of regular expressions for a cluster, but the approach can be used to generate a new regular expression for the newly identified attack substring, and then this regular expression can be added to the cluster's regular expressions. Also, the approach outlined above can be adapted to other types of network filter rules that may not be considered classic regular expressions.

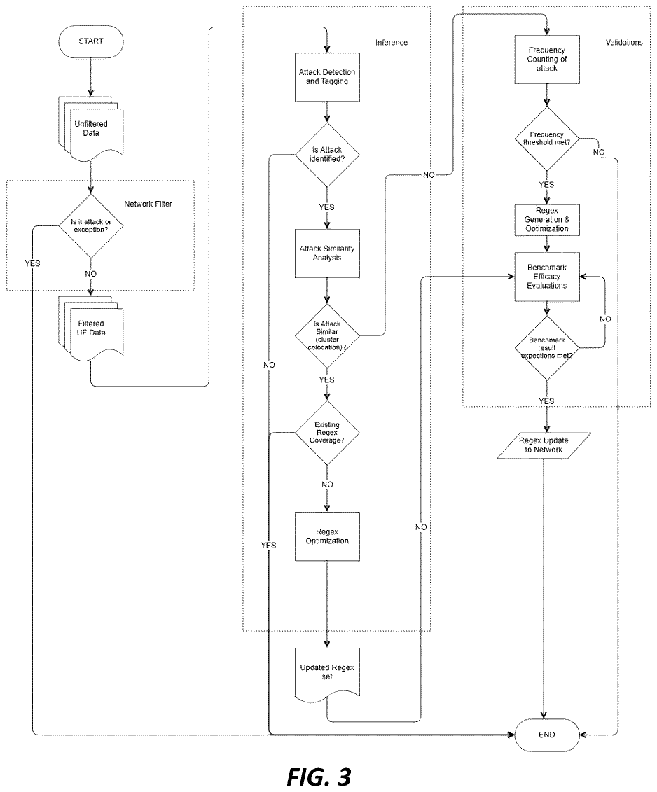

### FIG. 3 & System Flowchart

FIG. 3 illustrates an example of system operation in a flowchart form, including the stages described earlier. This example uses the clustering approach for the decoder.

First, unfiltered data (“UF data”) is processed by the network filter using existing regular expressions. Unfiltered data here includes network traffic that contains both benign and attack traffic. This part of the diagram thus refers to deployed network components, e.g., network firewalls.

If the network filter detects an attack, then the flow in FIG. 3 ends. This means that the network filter simply operates as currently configured, e.g., blocking or alerting on the attack in accord with the current configuration. If the network filter does not detect an attack (NO), then it passes the traffic as filtered UF data to the system for analysis.

The remainder of this workflow is dedicated to finding attacks in the traffic that the network filter thought was benign (false negatives) and then to developing a suitable regular expression for updating the network filter. It should be understood that in other embodiments, all traffic can be sent to the inference stage, because even if the network filter finds one attack, it may have missed others—this was mentioned earlier in the document. Also, in other embodiments, the system could operate on unfiltered traffic that has not passed through a network filter, as it could be used as a replacement for the network filter after tuning.

In the Inference stage, the input traffic is applied to the trained ML model that was described earlier in connection with FIGS. 1, 2A and 2B, and MMRC 104. Attack detection and sequence tagging is performed. If no attacks are found, the flow ends. If yes, then the tagged attack substring undergoes similarity analysis to determine whether it belongs to an existing cluster. (“Is Attack Similar (cluster colocation)?” step)

If the attack is similar to an existing cluster, then the regex coverage of the cluster is tested to see if it still covers the newly detected attack substring (“Existing Regex Coverage?”). If not, then the regex optimization routine is executed to adjust and improve the regex set. This updated set is sent for in-system testing (“Benchmark Efficacy Evaluations”), keeping in mind that this process is entirely automated.

The efficacy benchmarking process involves applying the new regex rules to a corpus of unfiltered traffic with known attacks embedded therein. A key performance indicator (‘KPI’) is established for true positive and false positive rates (e.g., the ruleset must find at least X percent of all attacks with less than Y percent false positives). If the efficacy standards are not met, then the ruleset must be improved and retested. Once the ruleset meets efficacy standards, it can be exported to the network-deployed network filters and installed to use against live traffic. (“Regex update to network”)

Returning to the “Is Attack Similar (cluster colocation)?” step, if the newly detected attack substring does not fit into any existing cluster, then the flow moves to the “Frequency Counting of attack” step. This means that the system monitors to see if this attack is detected with sufficient frequency over time. There could also be a requirement that the attack show up across a breadth of traffic (e.g., in many geographies, across a certain number of tenant/customer domains, and so on). This gating function helps ensure that spurious or immaterial attacks do not cause the generation of new clusters and new regex sets for the network filter to execute.

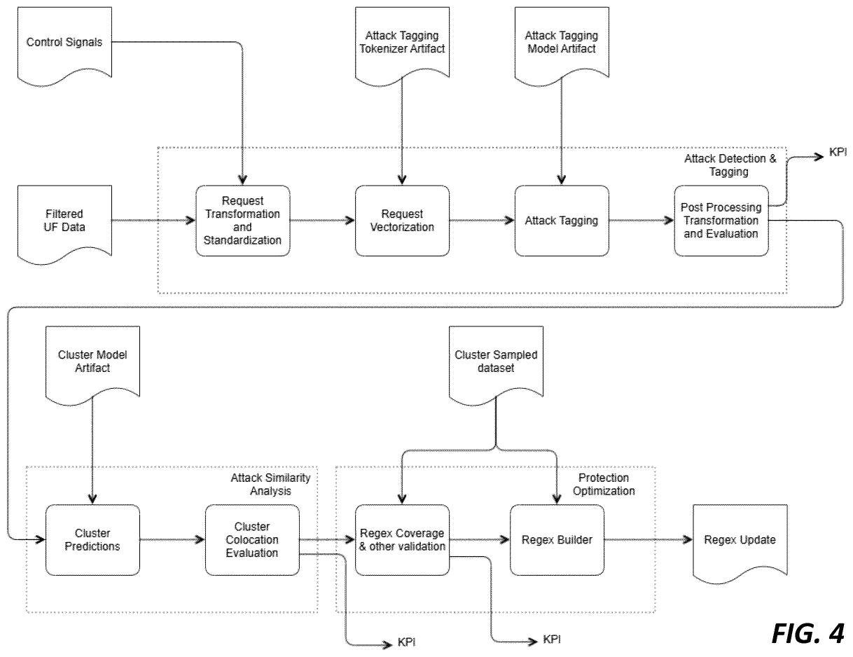

### FIG. 4 and System Inference Stages

FIG. 4 provides another view of an example system, a view that focuses on the inference stages in the pipeline.

The first stage is ‘Attack Detection and Tagging’. Processing begins with the transformation and standardization being applied to the filtered UF data. This stage filters network traffic for configuration-enabled customers of the system. Preferably this stage executes periodically, e.g., every 15 minutes. It filters requests for attack groups enabled for detection by that customer, detecting attack substrings found in traffic the network filter considered benign, and performs attack substring tagging. The tagged results are post processed. If an attack was identified then the results are passed to the next steps. If no attack was found then the evaluation process ends. The ‘attack tagging tokenizer artifact’ and the ‘attack tagging model artifact’ refer to the trained ML models described earlier (with respect to the MMRC 104). The data output for this stage includes, for a detected attack, a vectorized and tagged piece of network traffic (the tagged portion of an HTTP request).

The key performance indicators output for this stage include the execution volumes and performance (e.g., of inputs and outputs for each execution cycle), as well as efficacy metrics such as total positives and negatives, and false positives and negatives.

The next stage is ‘Attack Similarity Analysis’. This stage processes only the attack substring(s) identified in the prior stage. It clusters similar attacks together, evaluating similarity with pre-defined clusters. This stage can be executed periodically, e.g., every 15 minutes after the first stage. The Cluster Model Artifact refers to the trained ML clustering model that was mentioned earlier. Key performance indicators for this stage can include execution volumes and performance, as well as metrics such as Attacks Covered/day; Attacks Requiring regex Update/day; Cluster distance average/day; Number of system-vulnerable attacks Identified (to date); Number of system-vulnerable attack similarity counts (to date).

The next stage is ‘Protection Optimization’. This stage processes the similarity scores for the attack substring(s) that were produced in the prior stage. It identifies whether existing regex suffice to protect against new attacks, and it optimizes regexes to protect against recurrent new attacks. This stage can execute periodically, e.g., once a day. The Cluster Sampled Dataset refers to the clusters with constituent attack substrings and the regexes for each cluster. Generally, this stage determines one of the following:
a. Attack substrings in a cluster have a high similarity score, then regex coverage validation is not required.
b. Attack substrings in a cluster have medium or lower similarity score, then regex coverage validation is required
   Regex coverage validation checks if the regex associated to the closest cluster for a given attack substring, is able to ‘match’ (or block) the request. If coverage validation fails, then optimization is required. If a new attack substring is identified multiple times, and is not covered, then the regex needs to be updated. This is done by capturing system-vulnerable attacks in operational storage, and calculating similarity of new attacks with them. Key performance indicators for this stage can include execution volumes and performance, as well as Attacks Covered/day; Attacks Requiring regex Update/day; Cluster distance average/day; Number of attacks Identified (to date); Number of attack similarity counts (to date).

### Computer Based Implementation

The teachings hereof may be implemented using conventional computer systems, but modified by the teachings hereof, with the components and/or functional characteristics described above realized in special-purpose hardware, general-purpose hardware configured by software stored therein for special purposes, or a combination thereof, as modified by the teachings hereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus—such as a microprocessor in a computer, digital data processing device, or other computing apparatus—as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

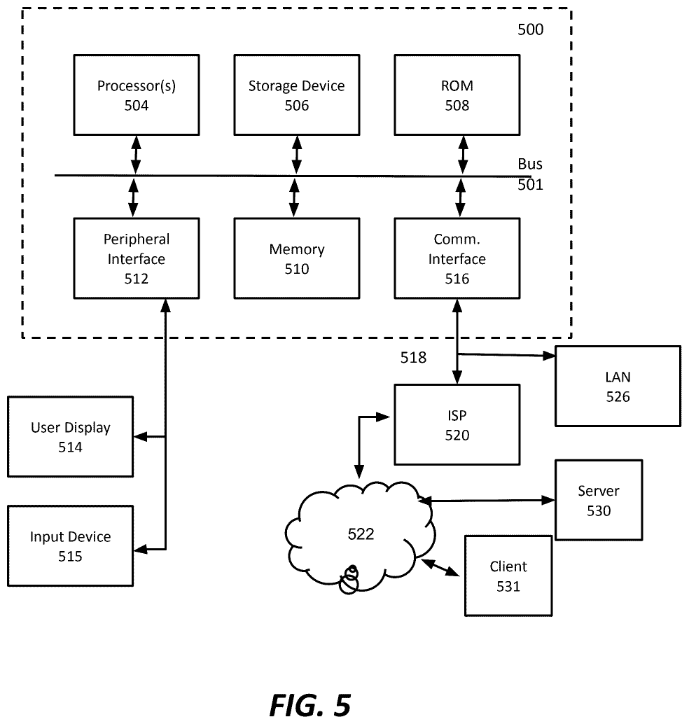

FIG. 5 is a block diagram that illustrates hardware in a computer system 500 upon which such software may run in order to implement embodiments of the invention. The computer system 500 may be embodied in a client device, server, personal computer, workstation, tablet computer, mobile or wireless device such as a smartphone, network device, router, hub, gateway, or other device. Representative machines on which the subject matter herein is provided may be a computer running a Linux or Linux-variant operating system and one or more applications to carry out the described functionality.

Computer system 500 includes a microprocessor 504 coupled to bus 501. In some systems, multiple processor and/or processor cores may be employed. Computer system 500 further includes a main memory 510, such as a random access memory (RAM) or other storage device, coupled to the bus 501 for storing information and instructions to be executed by processor 504. A read only memory (ROM) 508 is coupled to the bus 501 for storing information and instructions for processor 504. A non-volatile storage device 506, such as a magnetic disk, solid state memory (e.g., flash memory), or optical disk, is provided and coupled to bus 501 for storing information and instructions. Other application-specific integrated circuits (ASICs), field programmable gate arrays (FPGAs) or circuitry may be included in the computer system 500 to perform functions described herein.

A peripheral interface 512 may be provided to communicatively couple computer system 500 to a user display 514 that displays the output of software executing on the computer system, and an input device 515 (e.g., a keyboard, mouse, trackpad, touchscreen) that communicates user input and instructions to the computer system 500. However, in many embodiments, a computer system 500 may not have a user interface beyond a network port, e.g., in the case of a server in a rack. The peripheral interface 512 may include interface circuitry, control and/or level-shifting logic for local buses such as RS-485, Universal Serial Bus (USB), IEEE 1394, or other communication links.

Computer system 500 is coupled to a communication interface 516 that provides a link (e.g., at a physical layer, data link layer) between the system bus 501 and an external communication link. The communication interface 516 provides a network link 518. The communication interface 516 may represent an Ethernet or other network interface card (NIC), a wireless interface, modem, an optical interface, or other kind of input/output interface.

Network link 518 provides data communication through one or more networks to other devices. Such devices include other computer systems that are part of a local area network (LAN) 526. Furthermore, the network link 518 provides a link, via an internet service provider (ISP) 520, to the Internet 522. In turn, the Internet 522 may provide a link to other computing systems such as a remote server 530 and/or a remote client 531. Network link 518 and such networks may transmit data using packet-switched, circuit-switched, or other data-transmission approaches.

In operation, the computer system 500 may implement the functionality described herein as a result of the processor executing code. Such code may be read from or stored on a non-transitory computer-readable medium, such as memory 510, ROM 508, or storage device 506. Other forms of non-transitory computer-readable media include disks, tapes, magnetic media, SSD, CD-ROMs, optical media, RAM, PROM, EPROM, and EEPROM, flash memory. Any other non-transitory computer-readable medium may be employed. Executing code may also be read from network link 518 (e.g., following storage in an interface buffer, local memory, or other circuitry).

It should be understood that the foregoing has presented certain embodiments of the invention but they should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that any trademarks appearing herein are the property of their respective owners and used for identification and descriptive purposes only, and not to imply endorsement or affiliation in any way.

1. A method of automatically tuning a network filter, comprising:
receiving at least one attack substring that was identified as an attack within network traffic arriving at one or more network filters;
comparing the at least one attack substring to other attack substrings that have been grouped into a plurality of clusters, to determine a similarity level;
where each of the plurality of clusters is associated with: (i) a respective set of attack substrings and (ii) a respective set of one or more rules that are operable to detect the respective cluster's attack substrings within network traffic;
upon a determination that the at least one attack substring has a similarity level to a particular cluster that meets a configured threshold:
associating the at least one attack substring to the particular cluster,
updating the particular cluster's set of one or more rules to detect the at least one attack substring when the particular cluster's set of one or more rules does not do so, and
installing the updated set of one or more rules for the particular cluster in a network filter to identify additional attacks in network traffic.

2. The method of claim 1, wherein said comparing step comprises:
applying the at least one attack substring to a clustering model artifact.

3. The method of claim 1, further comprising: wherein updating the particular cluster's set of one or more rules comprises adding a new rule to cover the at least one attack substring.

4. The method of claim 1, further comprising: after said updating, optimizing the particular cluster's set of one or more rules to reduce a number of rules therein.

5. The method of claim 1, further comprising, upon a determination that the at least one attack substring does not have a similarity level meeting the configured threshold to any of the plurality of clusters:
generating a new cluster;
associating the new cluster with at least one new rule that detects the at least one attack substring in network traffic; and,
sending the at least one new rule to the one or more network filters to identify additional attacks in network traffic.

6. The method of claim 1, wherein the one or more network filters comprise one or more web application firewalls.

7. The method of claim 1, wherein the particular cluster's set of one or more rules comprise one or more regular expressions.

8. The method of claim 1, wherein the network traffic comprises application layer messages.

9. The method of claim 1, wherein the attack substring comprises at least a part of an HTTP message.

10. The method of claim 1, wherein a trained machine learning model identified the attack substring.

11. Apparatus comprising at least one first computer having circuitry forming memory for storing program instructions and forming a processor for executing the program instructions to:
receive at least one attack substring that was identified as an attack within network traffic arriving at one or more network filters;
compare the at least one attack substring to other attack substrings that have been grouped into a plurality of clusters, to determine a similarity level;
where each of the plurality of clusters is associated with: (i) a respective set of attack substrings and (ii) a respective set of one or more rules that are operable to detect the respective cluster's attack substrings within network traffic;
upon a determination that the at least one attack substring has a similarity level to a particular cluster that meets a configured threshold:
associate the at least one attack substring to the particular cluster,
update the particular cluster's set of one or more rules to detect the at least one attack substring when the particular cluster's set of one or more rules does not do so, and
install the updated set of one or more rules for the particular cluster in a network filter to identify additional attacks in network traffic.

12. A non-transitory computer readable medium storing computer program instructions for execution on one or more hardware processors in one or more computers, the computer program instructions when executed causing the one or more computers to operate at least by:
receiving at least one attack substring that was identified as an attack within network traffic arriving at one or more network filters;
comparing the at least one attack substring to other attack substrings that have been grouped into a plurality of clusters, to determine a similarity level;
where each of the plurality of clusters is associated with: (i) a respective set of attack substrings and (ii) a respective set of one or more rules that are operable to detect the respective cluster's attack substrings within network traffic;
upon a determination that the at least one attack substring has a similarity level to a particular cluster that meets a configured threshold:
associating the at least one attack substring to the particular cluster,
updating the particular cluster's set of one or more rules to detect the at least one attack substring when the particular cluster's set of one or more rules does not do so, and
installing the updated set of one or more rules for the particular cluster in a network filter to identify additional attacks in network traffic.
